(19) United States
(12) Patent Application Publication
(10) Pub. No.: US 2015/0062313 A1
(43) Pub. Date: Mar. 5, 2015

(54) DISPLAY CONTROL DEVICE, DISPLAY CONTROL METHOD, AND PROGRAM

(71) Applicant: SONY CORPORATION, Tokyo (JP)

(72) Inventor: Yuhei Taki, Kanagawa (JP)

(73) Assignee: SONY CORPORATION, Tokyo (JP)

(21) Appl. No.: 14/387,377

(22) PCT Filed: Feb. 4, 2013
(86) PCT No.: PCT/JP2013/052458

§ 371 Date: Sep. 23, 2014

(30) Foreign Application Priority Data
Mar. 30, 2012 (JP) 2012-080993

(51) Int. Cl. H04N 13/00; H04N 13/04

(52) U.S. Cl. CPC H04N 13/0033; H04N 13/0497; H04N 13/0484
USPC 348/55

(57) ABSTRACT

There is provided a display control device including an evaluation unit configured to evaluate difference between left-eye image data and right-eye image data which constitute image data, and a determination unit configured to determine which of a plane display type and a stereopsis display type is used for performing display using the image data, in response to an evaluation result from the evaluation unit.

### TECHNICAL FIELD

The present disclosure relates to a display control device, a display control method, and a program.

### BACKGROUND ART

Recently, a 3D display device which can cause a user to perceive a stereoscopic image by displaying a left-eye image (L image) and a right-eye image (R image) has been distributed. By using the 3D display device, while the user can obtain an effect that realistic sensation of the user is enhanced, the user easily gets eyestrain. Although there are diverse factors of the eyestrain, the factors include crosstalk occurring from a mixture of L images and R images, and flicker occurring from lack of a refresh rate of a liquid crystal shutter, as examples. Accordingly, a frame rate of a liquid crystal has been improved, and shutter grasses have been improved. However, a matter of the eyestrain has not solved enough.

In addition, in a case where display is extruded excessively or in a case where change of disparity difference is wide, fatigue of the user becomes severe. From such a standpoint, a technology of comfortable 3D display has been investigated. For example, Patent Literature 1 discloses a disparity conversion device configured to adjust disparity between an L image and an R image by shifting the L image and/or the R image in a horizontal direction.

Moreover, it has been considered that occurrence of the eyestrain depends not only on display types and equipment, but also individual characteristics of a user who views video and a way the user views the video. According to such situation, a guideline for viewing ways and equipment has been issued. For example, 3D Consortium promoting progress of 3D industry by public and private cooperation made a guideline for viewing stereoscopic video and aims to achieve comfortable stereoscopic-image viewing.

### CITATION LIST

### Patent Literature

Patent Literature 1: JP 2011-55022A

### SUMMARY OF INVENTION

### Technical Problem

As described above, by adjusting disparity or by devising viewing ways, it is possible to improve a certain amount of fatigue of the user. However, even if the disparity has been adjusted and the viewing ways have been devised, the fatigue of the user increases as time for viewing stereopsis-displayed video becomes longer.

Accordingly, the present disclosure proposes a novel and improved display control device, display control method, and program capable of decreasing eyestrain of a user.

### Solution to Problem

According to the present disclosure, there is provided a display control device including an evaluation unit configured to evaluate difference between left-eye image data and right-eye image data which constitute image data, and a determination unit configured to determine which of a plane display type and a stereopsis display type is used for performing display using the image data, in response to an evaluation result from the evaluation unit.

According to the present disclosure, there is provided a display control method including evaluating difference between left-eye image data and right-eye image data which constitute image data, and determining which of a plane display type and a stereopsis display type is used for performing display using the image data, in response to an evaluation result of the difference.

According to the present disclosure, there is provided a program causing a computer to function as an evaluation unit configured to evaluate difference between left-eye image data and right-eye image data which constitute image data, and a determination unit configured to determine which of a plane display type and a stereopsis display type is used for performing display using the image data, in response to an evaluation result from the evaluation unit.

### Advantageous Effects of Invention

As described above, according to the present disclosure, eyestrain of a user can be decreased.

### BRIEF DESCRIPTION OF DRAWINGS

FIG. 1 is an explanatory diagram showing a configuration of a display system according to an embodiment of the present disclosure.

FIG. 2 is an explanatory diagram showing a configuration of a display device according to a first embodiment.

FIG. 3 is an explanatory diagram showing a way of calculating extrusion amount of an image.

FIG. 4 is an explanatory diagram showing a determination example of a display type.

FIG. 5 is an explanatory diagram showing a relation between a threshold th and viewing time.

FIG. 6 is a flowchart showing operation of a display device according to the first embodiment.

FIG. 7 is an explanatory diagram showing a specific example of a notification window.

FIG. 8 is an explanatory diagram showing another notification example of a display type.

FIG. 9 is an explanatory diagram showing a configuration of a display device according to a second embodiment.

### DESCRIPTION OF EMBODIMENTS

Hereinafter, preferred embodiments of the present disclosure will be described in detail with reference to the appended drawings. Note that, in this specification and the drawings, elements that have substantially the same function and structure are denoted with the same reference signs, and repeated explanation is omitted.

Also, in the present specification and the drawings, different letters are sometimes suffixed to the same reference signs to distinguish a plurality of constituent elements having substantially the same functional configuration from each other. However, when it is not necessary to distinguish the plurality of constituent elements having substantially the same functional configuration, only the same reference signs are given.

Note that the present disclosure will be explained in the following order.

### 1. Fundamental Configuration of Display System

### 2. First Embodiment

2-1. Configuration of Display Device according to First Embodiment
2-2. Operation of Display Device according to First Embodiment

### 2-3. Supplemental Remarks

### 3. Second Embodiment

### 4. Conclusion

### 1. FUNDAMENTAL CONFIGURATION OF DISPLAY SYSTEM

A technology according to the present disclosure may be performed in various forms as described in detail in “2. First Embodiment” to “3. Second Embodiment” as examples. A display device 100 according to each embodiment having functions as a display control device includes:

A. an evaluation unit (extrusion-amount calculation unit 120) configured to evaluate difference between left-eye image data and right-eye image data which constitute image data; and
B. a determination unit (display-type determination unit 124) configured to determine whether a plane display type or a stereopsis display type is applied to performing display using the image data in response to an evaluation result from the evaluation unit.

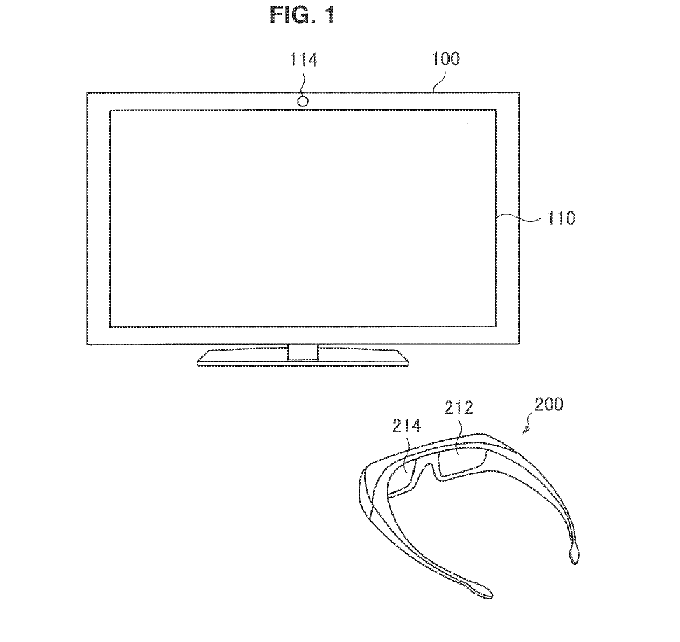

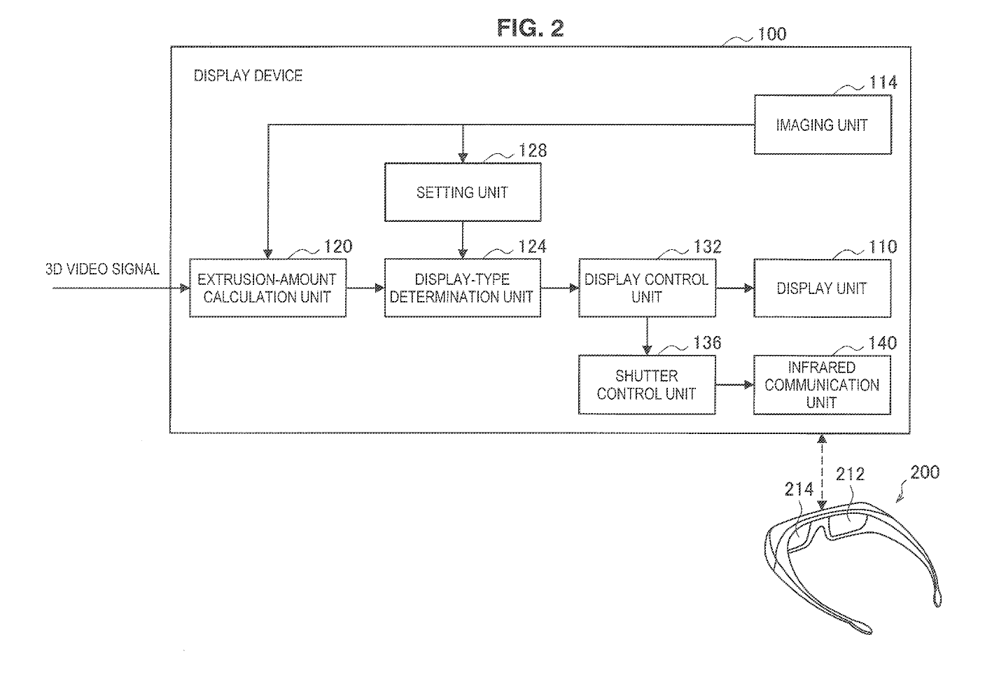

First, with reference to FIG. 1 and FIG. 2, a fundamental configuration of a display system which is common to each embodiment will be described as follows.

FIG. 1 is an explanatory diagram showing a configuration of a display system according to an embodiment of the present disclosure. As shown in FIG. 1, the display system according to the embodiment of the present disclosure includes a display device 100 and shutter glasses 200.

As shown in FIG. 1, the display device 100 includes a display unit 110 on which an image is displayed. The display device 100 can cause a user to perceive a stereoscopic image (3D image) by displaying a left-eye image (L image) and a right-eye image (R image) on the display unit 110. In addition, the display device 100 includes an imaging unit 114 for imaging a range from which the display device 100 can be viewed. By analyzing a captured image obtained by the imaging unit 114, it is possible to recognize a user who views the display device 100.

The shutter glasses 200 include a right-eye image transparent unit 212 and a left-eye image transparent unit 214 which are composed of a liquid crystal shutter, for example. The shutter glasses 200 performs open/close operation on the right-eye image transparent unit 212 and the left-eye image transparent unit 214 in response to a signal transmitted from the display device 100. The user can perceive, as a 3D image, the left-eye image and the right-eye image that are displayed on the display unit 110 by seeing light radiated from the display unit 110 through the right-eye image transparent unit 212 and the left-eye image transparent unit 214 of the shutter glasses 200.

On the other hand, in a case where a normal 2D image is displayed on the display unit 110, the user can perceive, as the normal 2D image, an image displayed on the display unit 110 by seeing light radiated from the display unit 110 without any operation.

FIG. 1 shows the display device 100 as an example of the display control device. However, the display control device is not limited thereto. For example, the display control device may be an information processing apparatus such as a personal computer (PC), a household video processing apparatus (a DVD recorder, a video cassette recorder, and the like), a personal digital assistant (PDA), a household game device, a cellular phone, a portable video processing apparatus, or a portable game device. Alternatively, the display control device may be a display installed at a theater or in a public space.

In addition, the present specification explains a control method using shifter operation so as to a left-eye image is perceived by a left eye and a right-eye image is perceived by a right eye. However, the control method is not limited thereto. For example, similar effect can be obtained by using a polarization filter for the left eye and a polarization filter for the right eye.

### Background

However, in a general display device having a 3D display function, fatigue of a user becomes severe in a case where display is extruded excessively or in a case where change of disparity is wide. From such a standpoint, a technology of comfortable 3D display has been investigated. For example, the technology of adjusting disparity between an L image and an R image by shifting the L image and/or the R image in a horizontal direction has been known. Moreover, it has been considered that occurrence of the eyestrain depends not only on display types and equipment, but also individual characteristics of a user who views video and a way the user views the video. According to such situation, a guideline for viewing ways and equipment has been issued. For example, 3D Consortium promoting progress of 3D industry by public and private cooperation made a guideline for viewing stereoscopic video and aims to achieve comfortable stereoscopic-image viewing.

As described above, by adjusting disparity or by devising viewing ways, it is possible to improve a certain amount of fatigue of the user. However, even if the disparity has been adjusted and the viewing ways have been devised, the fatigue of the user increases as time for viewing 3D-displayed video becomes longer.

Therefore, with the above circumstance taken into point of view, the display device 100 according to respective embodiments of the present disclosure has been achieved. The display device 100 according to the respective embodiments of the present disclosure can decrease eyestrain of a user. Hereinafter, there is subsequently and specifically described the display device 100 according to the respective embodiments of the present disclosure.

### 2. FIRST EMBODIMENT

### 2-1. Configuration of Display Device According to First Embodiment

FIG. 2 is an explanatory diagram showing a configuration of the display device 100 according to a first embodiment. As shown in FIG. 2, the display device 100 according to the first embodiment includes a display unit 110, an imaging unit 114, an extrusion-amount calculation unit 120, a display-type determination unit 124, a setting unit 128, a display control unit 132, a shutter control unit 136, and an infrared communication unit 140. Since the description is made in “1. Fundamental Configuration of Display System,” the repeated descriptions of the display unit 110 and the imaging unit 114 will be omitted hereafter.

### (Extrusion-Amount Calculation Unit)

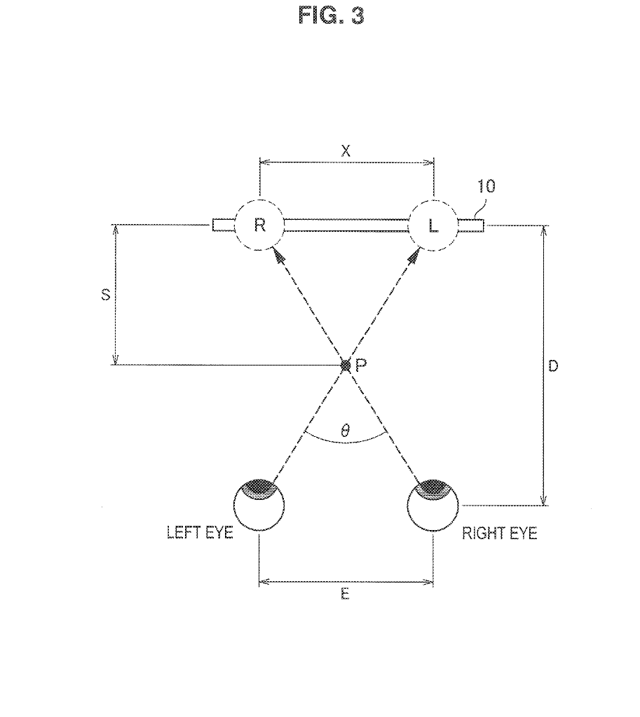

To the extrusion-amount calculation unit 120, a 3D video signal including image data composed of L image data and R image data is input. The 3D video signal may be a received video signal or a video signal read out from a storage medium. The extrusion-amount calculation unit 120 evaluates difference between the L image data and the R image data that are included in the 3D video signal. For example, the extrusion-amount calculation unit 120 calculates extrusion amount from the display unit 110 to a position at which the user perceives that an image exists when 3D display is performed on the basis of the L image data and the R image data. With reference to FIG. 3, a specific example of a way of calculating the extrusion amount will be explained hereinafter.

FIG. 3 is an explanatory diagram showing a way of calculating extrusion amount of an image. As shown in FIG. 3, when an R image and an L image are displayed at different positions on the display unit 110, the user perceives that an image exists at an intersection (hereinafter, perception position P) between a line connecting the right eye and the R image and a line connecting the left eye and the L image.

By using an interval E between the left eye and the right eye of the user, a distance D between the user and the display unit 110, and difference X between the L image and the R image that are shown in FIG. 3, a distance between the perception position P and the display unit 110, that is, extrusion amount S of the perception position P from the display unit 110 is calculated in accordance with the following numerical formula, for example.

Extrusion Amount S=D×X/(X+E)

Note that, the interval E between the left eye and the right eye of the user and the distance D between the user and the display unit 110 can be estimated from a captured image acquired by the imaging unit 114. Alternatively, the interval E between the left eye and the right eye of the user and the distance D between the user and the display unit 110 may be values set in advance.

Note that, the difference X between the L image and the R image can be identified using diverse ways. For example, the extrusion-amount calculation unit 120 can identify the difference X by using a stereo matching method of extracting feature points in the L image and the R image and measuring gaps between the feature points. More specifically, the stereo matching method includes a feature-based method and an area-based method. The feature-based method extracts edges in an image on the basis of brightness values, extracts edge strengths and edge directions as feature points, and measures gaps between similar edge points. The area-based method analyses a degree of matching of patterns for every certain image area, and measures gaps between similar image areas.

Note that, the example in which the extrusion amount is the distance between the perception point P and the display unit 110 has been explained in the above description. However, the present embodiment is not limited thereto. For example, an angle of convergence θ shown in FIG. 3 may be used as the extrusion amount. Note that, the extrusion-amount calculation unit 120 may divide a 3D video signal for unit time and may calculate an average of the extrusion amount in a section.

### (Display-Type Determination Unit)

The display-type determination unit 124 determines whether sufficient stereoscopic effect can be obtained when 3D display is performed on the basis of the 3D video signal. Subsequently, in a case where it has been determined that the sufficient stereoscopic effect is obtained, the display-type determination unit 124 instructs the display control unit 132 to perform the 3D display. On the other hand, in a case where it has been determined that the sufficient stereoscopic effect is not obtained even if the 3D display is performed, the display-type determination unit 124 instructs the display control unit 132 to perform 2D display.

More specifically, the display-type determination unit 124 determines, on the basis of the extrusion amount S calculated by the extrusion-amount calculation unit 120, whether the sufficient stereoscopic effect is obtained when the 3D display is performed. Here, it is considered that the stereoscopic effect increases as the extrusion amount S calculated by the extrusion-amount calculation unit 120 becomes bigger. Accordingly, in a case where the extrusion amount S calculated by the extrusion-amount calculation unit 120 is greater than or equals to a threshold th set by the setting unit 128 described later, the display-type determination unit 124 instructs the display control unit 132 to perform the 3D display. On the other hand, in a case where the extrusion amount S is less than the threshold th, the display-type determination unit 124 instructs the display control unit 132 to perform the 2D display.

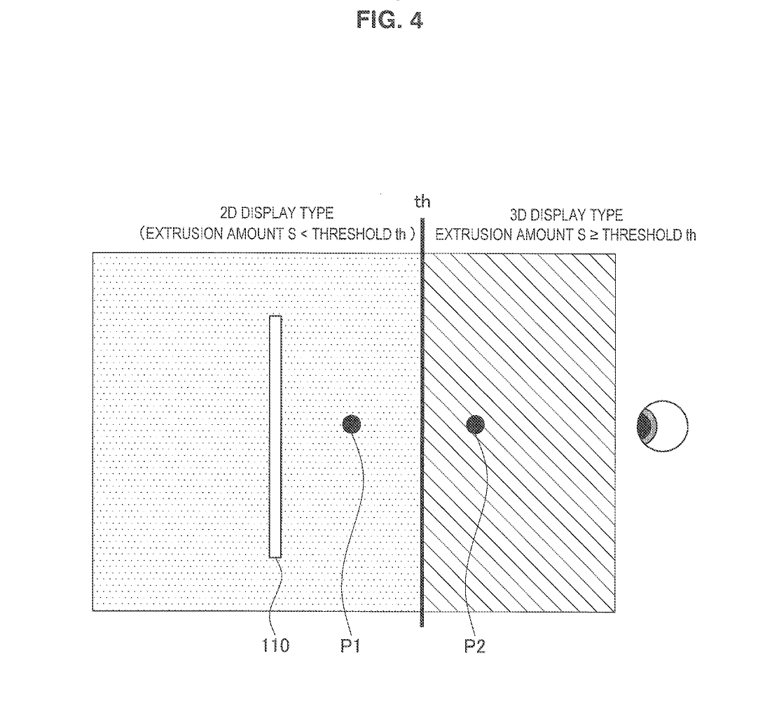

For example, in a case where a perception position of 3D display based on certain image data is a position P1 shown in FIG. 4, extrusion amount S at the position P1 is less than the threshold th. Accordingly, the display-type determination unit 124 instructs the display control unit 132 to perform 2D display based on the certain image data. On the other hand, in a case where the perception position of 3D display based on the certain image data is a position P2 shown in FIG. 4, extrusion amount S at the position P2 is greater than or equals to the threshold th. Accordingly, the display-type determination unit 124 instructs the display control unit 132 to perform 3D display based on the certain image data.

### (Setting Unit)

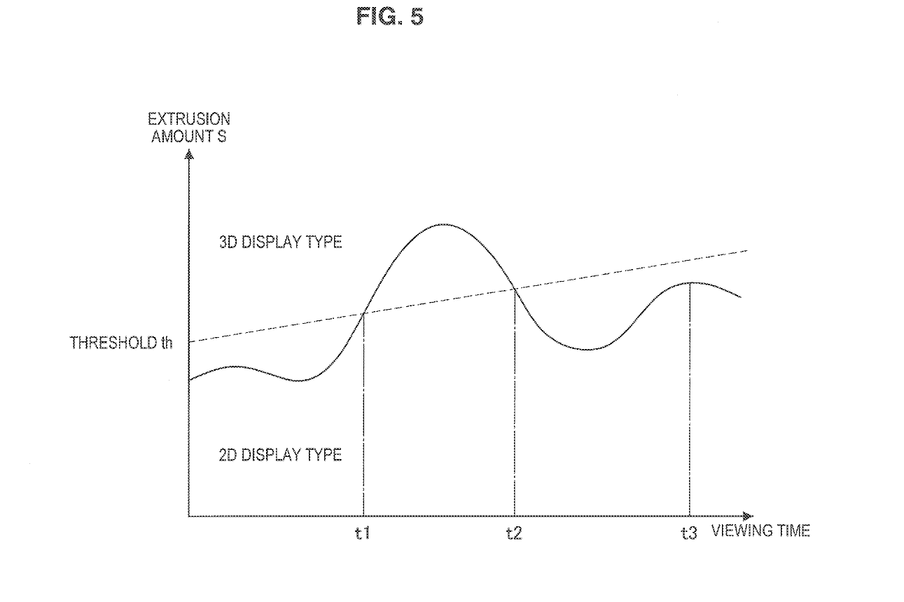

The setting unit 128 sets the threshold used by the display-type determination unit 124 for determining a display type. For example, in a case where viewing time of the user becomes longer, it is considered that the user accumulates fatigue. Accordingly, the setting unit 128 may raise the threshold th as the viewing time of the user becomes longer. In such a configuration, it is possible to decrease frequency of 3D display in a case where the viewing time of the user becomes longer. With reference to FIG. 5, specific examples will be given as follows.

FIG. 5 is an explanatory diagram showing a relation between a threshold th and viewing time. As shown in FIG. 5, the setting unit 128 may continuously increase the threshold th as the viewing time becomes longer. In an example in FIG. 5, since extrusion amount S in t1 to t2 exceeds the threshold th, 3D display is performed in t1 to t2. However, near t3 where extrusion amount S is relatively high and where 3D display is performed if the threshold th remains the initial value, since extrusion amount S falls below the increased threshold th, 3D display is not performed. As described above, by continuously increasing the threshold th as the viewing time becomes longer, it becomes difficult to perform 3D display. Accordingly, it is possible to decrease eyestrain of the user.

Note that, the way of setting a threshold th is not limited to the above-described way using viewing time. For example, since it has been worried about effect of 3D video to visual function development of a child user, the setting unit 128 may determine whether a user is an adult or a child, and in a case where the user is a child, the setting unit 128 may set the threshold th at a higher value than a case where the user is an adult. Note that, it is possible to estimate whether the user is an adult or a child on the basis of a captured image acquired by the imaging unit 114.

Alternatively, the setting unit 128 may set the threshold value by considering video additional information (for example, a genre of the video and duration) included in a 3D video signal, input from a sensor capable of acquiring a viewing environment, information (eyesight, wearing contacts or glasses, age, distance between eyes) about a living body of the user, a type (a portable device, s stationary device, a screen) of the display device 100 or the like. In addition, the setting unit 128 may set the threshold th at a value designated by the user in accordance with user operation.

### (Display Control Unit)

The display control unit 132 controls display on the display unit 110 in accordance with a display type designated by the display-type determination unit 124. Specifically, the display control unit 132 causes the display unit 110 to perform 3D display based on an L image and an R image in a case where the display type designated by the display-type determination unit 124 is a 3D display type, or the display control unit 132 causes the display unit 110 to perform 2D display based on an L image and an R image in a case where the display type designated by the display-type determination unit 124 is a 2D display type.

Here, when switching the display type, the display control unit 132 generates an interpolation image in which difference between the L image and the R image is suppressed, and causes the display unit 110 to display the interpolation image in a process of switching the display type. In such a configuration, it is possible to switch the display type without the user being aware of the switching. Accordingly, it is possible for a user to ease a burden and incongruity that are associated with the switching.

For example, when switching from the 2D display type to the 3D display type, the display control unit 132 may reduce difference between the L image and the R image of frames having faster display timing from among a sequence of frames, may gradually ease a degree of suppression of the difference between the L image and the R image, and may achieve continuous switching. Alternatively, it is also possible for the display control unit 132 to switch the display type in accordance with diverse statistical rules and mathematical rules such as linear interpolation and non-linear interpolation.

Note that, the display control unit 132 may use another way of easing the burden and the incongruity on the user, which are associated with the switching. For example, when switching from the 2D display type to the 3D display type, the display control unit 132 can obtain an effect similar to the above by blurring an image having faster display timing from among the sequence of frames and by gradually making the image clear.

### (Shutter Control Unit and Infrared Communication Unit)

The shutter control unit 136 generates a shutter control signal for controlling shutter operation of the shutter glasses 200 when a display type designated by the display-type determination unit 124 is the 3D display type. In the shutter glasses 200, open/close operation of the right-eye image transparent unit 212 and the left-eye image transparent unit 214 is performed on the basis of the shutter control signal generated by the shutter control unit 136 and emitted from the infrared communication unit 140. Specifically, the shutter operation is performed in a manner that the left-eye image transparent unit 214 opens while the left-eye image is displayed on the display unit 110 and the right-eye image transparent unit 212 opens while the right-eye image is displayed on the display unit 110.

### 2-2. Operation of Display Device According to First Embodiment

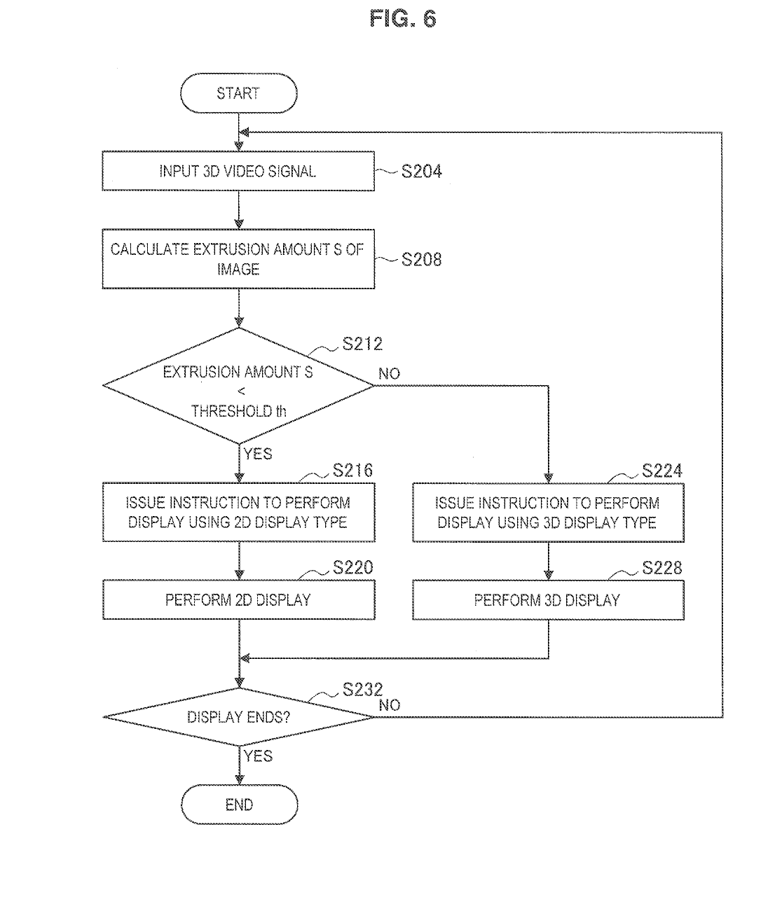

The configuration of the display device 100 according to the first embodiment has been explained. Next, with reference to FIG. 6, operation of the display device 100 according to the first embodiment will be described.

FIG. 6 is a flowchart showing operation of the display device 100 according to the first embodiment. As shown in FIG. 6, a 3D video signal is first input to the extrusion-amount calculation unit 120 (S204). Subsequently, on the basis of L image data and R image data included in the 3D video signal, the extrusion-amount calculation unit 120 calculates extrusion amount S of an image in a case where 3D display is performed (S208).

Next, the display-type determination unit 124 determines whether the extrusion amount S calculated by the extrusion-amount calculation unit 120 is greater than or equals to a threshold th set by the setting unit 128 (S212). Subsequently, in a case where the extrusion amount S is less than the threshold th set by the setting unit 128 (YES in step S212), the display-type determination unit 124 instructs the display control unit 132 to perform display using the 2D display type (S216). Accordingly, the display control unit 132 causes the display unit 110 to perform the 2D display (S220).

On the other hand, in a case where the extrusion amount S is greater than or equals to the threshold th (NO in step S212), the display-type determination unit 124 instructs the display control unit 132 to perform the 3D display (S224). Accordingly, the display control unit 132 causes the display unit 110 to perform the 3D display (S228). Subsequently, the display device 100 repeats the processing of S204 to S228 until display based on the 3D video signal ends (S232).

### 2-3. Supplemental Remarks

The configuration and the operation of the display device 100 according to the first embodiment of the present disclosure have been explained. Hereinafter, supplemental remarks about the first embodiment will be described.

### (Notification of Display Type)

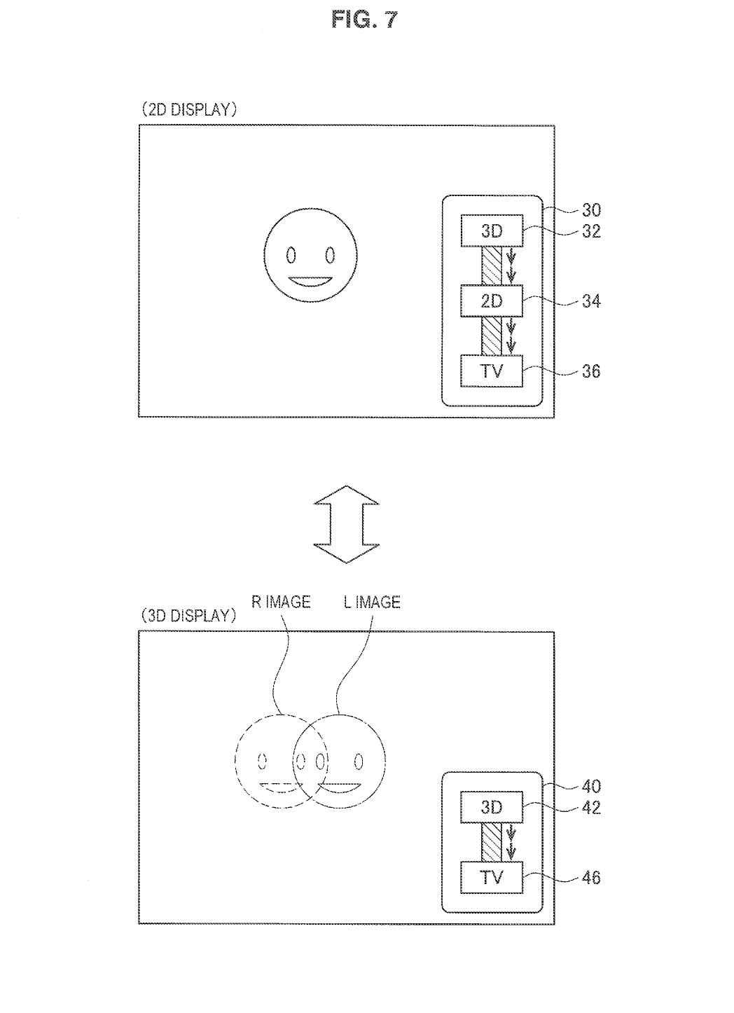

The display control unit 132 may overlay a notification window for notifying the user of a current display type on a screen. With reference to FIG. 7, specific examples will be given as follows.

FIG. 7 is an explanatory diagram showing a specific example of a notification window. As shown in FIG. 7, in a case where the display type is the 2D display type, a notification window 30 includes a supply-source object 32, a 2D-display notification object 34, and a device object 36. The supply-source object 32 indicates that a supplied video signal is a 3D video signal, the 2D-display notification object 34 indicates that a 2D video signal is generated from the 3D video signal, and the device object 36 indicates that the display device 100 performs display based on the 2D video signal.

On the other hand, as shown in FIG. 7, in a case where the display type is the 3D display type, a notification window 40 includes a supply-source object 42 and a device object 46. The supply-source object 42 indicates that a supplied video signal is a 3D video signal, and the device object 46 indicates that the display device 100 performs display based on the 3D video signal. Moreover, the display control unit 132 performs control in a manner that the notification window 30 or notification window 40 is displayed for a certain time when the display type is switched.

On the basis of such a notification window 30, the user can easily recognize whether the current display type is the 2D display type or the 3D display type.

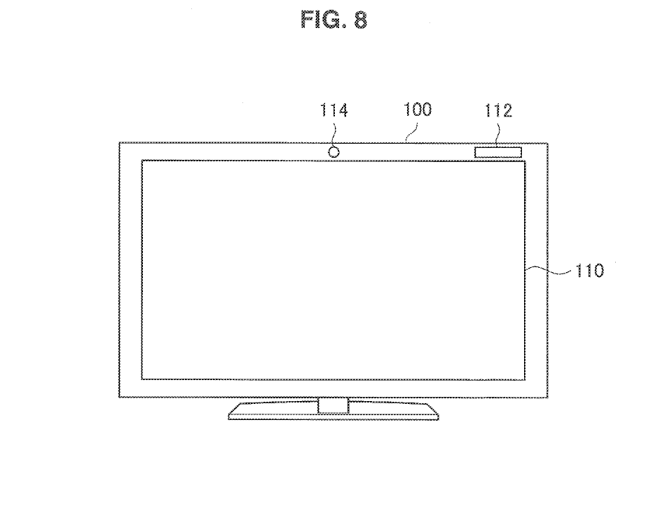

Note that, the notification way of the display type is not limited thereto. For example, as shown in FIG. 8, it may be possible that a light-emitting unit 112 is provided on a front surface of the display device 100 and the light-emitting unit 112 emits light in a case where the display type is the 3D display type. In such a configuration, the user can be notified of the display type without disturbing viewing of a content image displayed on the display unit 110.

### (Control Based on Gaze of User)

While 3D display is performed on the display device 100, attention of the user may be shifted to another device such as a mobile device. In this period, flicker occurs when the user sees the another device if the shutter operation of the shutter glasses 200 continues. In addition, there is little significance of performing the 3D display on the display device 100 while the user does not see the display device 100.

Accordingly, the shutter control unit 136 may stop the shutter operation of the shutter glasses 200 in a case where the attention of the user wanders from the display device 100. Note that, it is possible to determine whether the attention of the user wanders from the display device 100 by recognizing gaze of the user from the captured image acquired by the imaging unit 114. In such a configuration, the user can use the another device comfortably without taking off the shutter glasses 200.

In addition, the display control unit 132 may stop 3D display on the display unit 110 in a case where the attention of the user wanders from the display device 100. Moreover, the display device 100 may turn off a power supply of the display device 100 in the case where the attention of the user wanders from the display device 100. In such a configuration, it is possible to reduce power consumption of the display device 100.

### 3. SECOND EMBODIMENT

The first embodiment of the present disclosure has been explained. Next, a second embodiment of the present disclosure will be explained.

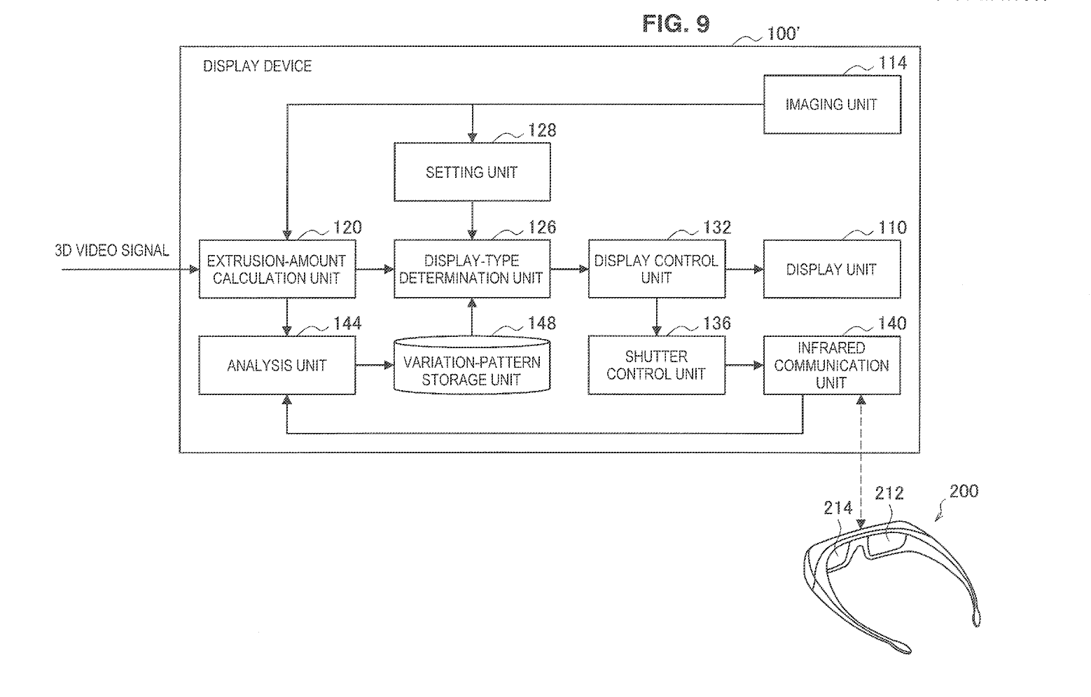

FIG. 9 is an explanatory diagram showing a configuration of a display device 100′ according to a second embodiment. As shown in FIG. 9, the display device 100′ according to the second embodiment includes a display unit 110, an imaging unit 114, an extrusion-amount calculation unit 120, a display-type determination unit 126, a setting unit 128, a display control unit 132, a shutter control unit 136, an infrared communication unit 140, an analysis unit 144, and a variation-pattern storage unit 148. Since the description is made in “2. First Embodiment,” the repeated descriptions of the display unit 110, the imaging unit 114, the extrusion-amount calculation unit 120, the setting unit 128, the display control unit 132, and the shutter control unit 136 will be omitted hereinafter.

The display device 100′ according to the second embodiment acquires biological information of a user such as pulses and movement of mimic muscles from a user using device. For example, the shutter glasses 200 worn by the user acquires biological information of the user, and the infrared communication unit 140 receives the biological information of the user from the shutter glasses 200.

On the basis of changes in the biological information of the user, the analysis unit 144 analyses an image pattern which causes the user to get fatigue. For example, in a case where the biological information of the user indicates that the user gets fatigue, the analysis unit 144 analyses a variation pattern of difference (that is, variation pattern of extrusion amount) between an L image and an R image that are displayed when the biological information is acquired. Subsequently, the variation-pattern storage unit 148 stores the variation pattern acquired from the analysis performed by the analysis unit 144. For example, the variation pattern includes a pattern in which an increase and decrease of the extrusion amount is repeated three times in a unit period.

The display-type determination unit 126 determines whether a variation pattern of extrusion amount calculated by the extrusion-amount calculation unit 120 matches with a variation pattern stored in the variation-pattern storage unit 148. Here, in a case where the variation pattern of the extrusion amount calculated by the extrusion-amount calculation unit 120 matches with the variation pattern stored in the variation-pattern storage unit 148, it is considered that the 3D display causes the user to get fatigue. Accordingly, in the case where the variation pattern of the extrusion amount calculated by the extrusion-amount calculation unit 120 matches with the variation pattern stored in the variation-pattern storage unit 148, the display-type determination unit 126 instructs the display control unit 132 to perform 2D display.

According to the above-described second embodiment, it is possible to automatically generate a 3D-display condition tailored to an individual user on the basis of biological information of the user acquired while the user views 3D video, and it is also possible to determine the display type according to the 3D-display condition.

### 4. CONCLUSION

As described above, according to the embodiments of the present disclosure, duration in which the 3D display is performed can be decreased, and eyestrain of the user can be reduced. Further according to the embodiments of the present disclosure, it is possible for a user to ease a burden and incongruity that are associated with the switching since the switching of the display type is continuously performed.

Moreover, according to the embodiments of the present disclosure, power consumption can be reduced since unnecessary 3D display or driving of shutter glasses can be suppressed by estimating a gaze direction of the user. Further, according to the embodiments of the present disclosure, it is possible to automatically generate a 3D-display condition tailored to an individual user on the basis of biological information of the user acquired while the user views 3D video, and it is also possible to determine the display type according to the 3D-display condition.

In addition, the eyestrain of the user from the 3D display can be decreased. Accordingly, it is possible to impress a user who concerns about bad effect of the 3D display with attractions of the 3D display. In this way, the embodiments of the present disclosure can contribute the progress of 3D industry.

The preferred embodiments of the present disclosure have been described above with reference to the accompanying drawings, whilst the present disclosure is not limited to the above examples, of course. A person skilled in the art may find various alterations and modifications within the scope of the appended claims, and it should be understood that they will naturally come under the technical scope of the present invention.

For example, it may not be necessary to chronologically execute respective steps in the processing, which is executed by the display device 100 according to this specification, in the order described in the flowchart. For example, the respective steps in the processing which is executed by display device 100 may be processed in the order different from the order described in the flow charts, and may also be processed in parallel.

Further, a computer program for causing hardware, such as a CPU, ROM and RAM built into the display device 100 to exhibit functions the same as each of the elements of the above described display device 100 can be created. Further, a storage medium on which this computer program is recorded can also be provided.

Additionally, the present technology may also be configured as below.

(1)

A display control device including:

an evaluation unit configured to evaluate difference between left-eye image data and right-eye image data which constitute image data; and

a determination unit configured to determine which of a plane display type and a stereopsis display type is used for performing display using the image data, in response to an evaluation result from the evaluation unit.

(2)

The display control device according to (1),

wherein the determination unit
determines that the display is performed using the stereopsis display type in a case where the evaluation unit evaluates the difference as satisfying a threshold condition, and
determines that the display is performed using the plane display type in a case where the evaluation unit evaluates the difference as not satisfying the threshold condition.
   (3)

The display control device according to (2), further including:

a setting unit configured to set the threshold condition.

(4)

The display control device according to (3),

wherein the setting unit sets the threshold condition on the basis of continuous use time of a display device by a user of the display device, the display device performing display using the image data.

(5)

The display control device according to (4),

wherein the setting unit narrows a range of the difference satisfying the threshold condition as the continuous use time becomes longer.

(6)

The display control device according to any one of (3) to (5),

Wherein the setting unit sets the threshold condition on the basis of an attribute of a user of a display device performing display using the image data.

(7)

The display control device according to (6),

wherein, in a case where the user is a child, the setting unit narrows a range of the difference satisfying the threshold condition more than the range of the difference satisfying the threshold condition in a case where the user is an adult.

(8)

The display control device according to (3),

wherein the setting unit sets the threshold condition in accordance with user operation.

(9)

The display control device according to (1), further including:

a storage unit configured to store a specific variation pattern of the difference,

wherein the determination unit performs the determination on the basis of whether or not a variation pattern of difference between left-eye image data and right-eye image data of target image data matches with the specific variation pattern stored in the storage unit.

(10)

The display control device according to (8), further including:

an analysis unit configured to analyze left-eye image data and right-eye image data of image data to which biological information of a user shows a specific reaction when display is performed using the stereopsis display type, and then extract the specific variation pattern.

(11)

The display control device according to any one of (1) to (10), further including:

a display control unit configured to control display in accordance with a determination result from the determination unit, the display being performed by a display device,

wherein, in a case where a display type is switched between the plane display type and the stereopsis display type, the display control unit generates an interpolation image in which difference between the left-eye image data and the right-eye image data is suppressed, and causes the display device to display the interpolation image in a process of switching the display type.

(12)

A display control method including:

evaluating difference between left-eye image data and right-eye image data which constitute image data; and

determining which of a plane display type and a stereopsis display type is used for performing display using the image data, in response to an evaluation result of the difference.

(13)

A program causing a computer to function as:

an evaluation unit configured to evaluate difference between left-eye image data and right-eye image data which constitute image data; and

a determination unit configured to determine which of a plane display type and a stereopsis display type is used for performing display using the image data, in response to an evaluation result from the evaluation unit.

(14)

The program according to (13),

wherein the determination unit
determines that the display is performed using the stereopsis display type in a case where the evaluation unit evaluates the difference as satisfying a threshold condition, and
determines that the display is performed using the plane display type in a case where the evaluation unit evaluates the difference as not satisfying the threshold condition.
   (15)

The program according to (14), further causing the computer to function as:

a setting unit configured to set the threshold condition.

(16)

The program according to (14) or (15),

wherein the setting unit sets the threshold condition on the basis of continuous use time of a display device by a user of the display device, the display device performing display using the image data.

(17)

The program according to any one of (14) to (16),

wherein the setting unit sets the threshold condition on the basis of an attribute of a user of a display device performing display using the image data.

### REFERENCE SIGNS LIST

100, 100′ display device
110 display unit
112 light-emitting unit
114 imaging unit
120 amount calculation unit
124, 126 display-type determination unit
128 setting unit
132 display control unit
136 shutter control unit
140 infrared communication unit
144 analysis unit
148 variation-pattern storage unit
200 shutter glasses
212 right-eye image transparent unit
214 left-eye image transparent unit

1. A display control device comprising:
an evaluation unit configured to evaluate difference between left-eye image data and right-eye image data which constitute image data; and
a determination unit configured to determine which of a plane display type and a stereopsis display type is used for performing display using the image data, in response to an evaluation result from the evaluation unit.

2. The display control device according to claim 1,
wherein the determination unit
determines that the display is performed using the stereopsis display type in a case where the evaluation unit evaluates the difference as satisfying a threshold condition, and
determines that the display is performed using the plane display type in a case where the evaluation unit evaluates the difference as not satisfying the threshold condition.

3. The display control device according to claim 2, further comprising:
a setting unit configured to set the threshold condition.

4. The display control device according to claim 3,
wherein the setting unit sets the threshold condition on the basis of continuous use time of a display device by a user of the display device, the display device performing display using the image data.

5. The display control device according to claim 4,
wherein the setting unit narrows a range of the difference satisfying the threshold condition as the continuous use time becomes longer.

6. The display control device according to claim 3,
Wherein the setting unit sets the threshold condition on the basis of an attribute of a user of a display device performing display using the image data.

7. The display control device according to claim 6,
wherein, in a case where the user is a child, the setting unit narrows a range of the difference satisfying the threshold condition more than the range of the difference satisfying the threshold condition in a case where the user is an adult.

8. The display control device according to claim 3,
wherein the setting unit sets the threshold condition in accordance with user operation.

9. The display control device according to claim 1, further comprising:
a storage unit configured to store a specific variation pattern of the difference,
wherein the determination unit performs the determination on the basis of whether or not a variation pattern of difference between left-eye image data and right-eye image data of target image data matches with the specific variation pattern stored in the storage unit.

10. The display control device according to claim 8, further comprising:
an analysis unit configured to analyze left-eye image data and right-eye image data of image data to which biological information of a user shows a specific reaction when display is performed using the stereopsis display type, and then extract the specific variation pattern.

11. The display control device according to claim 1, further comprising:
a display control unit configured to control display in accordance with a determination result from the determination unit, the display being performed by a display device,
wherein, in a case where a display type is switched between the plane display type and the stereopsis display type, the display control unit generates an interpolation image in which difference between the left-eye image data and the right-eye image data is suppressed, and causes the display device to display the interpolation image in a process of switching the display type.

12. A display control method comprising:
evaluating difference between left-eye image data and right-eye image data which constitute image data; and
determining which of a plane display type and a stereopsis display type is used for performing display using the image data, in response to an evaluation result of the difference.

13. A program causing a computer to function as:
an evaluation unit configured to evaluate difference between left-eye image data and right-eye image data which constitute image data; and
a determination unit configured to determine which of a plane display type and a stereopsis display type is used for performing display using the image data, in response to an evaluation result from the evaluation unit.

14. The program according to claim 13,
wherein the determination unit
determines that the display is performed using the stereopsis display type in a case where the evaluation unit evaluates the difference as satisfying a threshold condition, and
determines that the display is performed using the plane display type in a case where the evaluation unit evaluates the difference as not satisfying the threshold condition.

15. The program according to claim 14, further causing the computer to function as:
a setting unit configured to set the threshold condition.

16. The program according to claim 15,
wherein the setting unit sets the threshold condition on the basis of continuous use time of a display device by a user of the display device, the display device performing display using the image data.

17. The program according to claim 15,
wherein the setting unit sets the threshold condition on the basis of an attribute of a user of a display device performing display using the image data.
